(19) United States
(12) Patent Application Publication
(10) Pub. No.: US 2010/0177530 A1
(43) Pub. Date: Jul. 15, 2010

(54) VEHICLE HEADLINER MODULE

(75) Inventor: David Huelke, Milan, MI (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Global Technologies, LLC, Dearborn, MI (US)

(21) Appl. No.: 12/352,776

(22) Filed: Jan. 13, 2009

(51) Int. Cl. B60Q 3/02

(52) U.S. Cl. 362/545; 362/546; 362/544

(57) ABSTRACT

A module adapted to be mounted in a vehicle interior is disclosed which has a housing with two switch-controllable map lamps mounted symmetrically in the housing and a centrally-located aperture in the housing adapted to accept one of a speaker assembly and a dome lamp. When the vehicle is equipped with the speaker, the map lamps are switched on when a door switch indicating that a door is open, thereby fulfilling the function of the dome lamp. The map lamps are additionally activated by a switch coupled to the lamp or mounted in the module. When the vehicle is not equipped with the speaker, a dome lamp is mounted in the aperture.

### BACKGROUND

1. Technical Field

The invention relates generally to structures for mounting components in a vehicle interior and more specifically to modules for mounting speakers and lights.

2. Background Art

Automotive manufacturers prefer to offer content options to their customers to satisfy a wide range in customer desires and tastes. However, increasing the number of options complicates the design and manufacturing process. For example, it may be desirable to offer an upgraded stereo system which requires the mounting of multiple speakers throughout the vehicle cabin. However, not all customers purchase the upgraded stereo system. One solution is to put a blank in the spots where the upgraded stereo speakers would be placed for the customers who do choose the upgraded system. Sometimes, this is not an attractive or efficient alternative. Another problem is that the vehicle interior must be designed to accommodate every variation of optional equipment. The number of different opening dimensions and simply the number of openings required can complicate the design and provide less than a clean look.

### SUMMARY

Disadvantages in the prior art are overcome by providing structure such as a module adapted to be mounted in an aperture sized to receive the structure in an automotive vehicle interior. A variety of components may be carried in the module in different function and geometric arrangements. According to one exemplary embodiment a module may have a housing, a first lamp mounted in the housing which is manually switchable by a first switch electrically coupled to the first lamp; a second lamp mounted in the housing which is manually switchable by a second switch electrically coupled to the second lamp; and a speaker mounted in the housing. The first and second lamps are displaced from a center of the module symmetrically and the center of the speaker's face is generally aligned with the center of the module's face. A door switch is electrically coupled via a controller to the first and second lamps such that power is applied to the first and second lamps when the door switch indicates that the vehicle door is open and power is cut off to the first and second lamps when the door switch indicates that the vehicle door is closed.

Also disclosed, as a further exemplary embodiment, is a module mounted in a vehicle interior having a housing into which two switch-controllable lamps are mounted and a centrally-located aperture adapted to accept a speaker assembly or a dome lamp. The dome lamp may be incandescent or a light emitting diode of any color. The first and second lamps are electrically coupled to a door switch via a controller so that power is provided to the first and second lamps when a door of the vehicle is open. The first and second lamps also have a manually operated switch coupled in parallel with the door switch.

Alternatively, a speaker is mounted in the aperture. In one embodiment the speaker has a light bar. The light bar may be mounted at the periphery of the speaker and the light bar may have LEDs. The center of the speaker with respect to the face of the speaker coincides with a center of the face of the module. In one embodiment, the plane of the face of the speaker is angled with respect to the plane of the module face.

According to another exemplary embodiment, a module mounted in an automotive vehicle interior, having a first map lamp which is manually switchable by a first switch electrically coupled to the first map lamp; a second map lamp which is manually switchable by a second switch electrically coupled to the second map lamp; and a speaker is disclosed. The first and second map lamps are displaced from a center of the module symmetrically and the center of the speaker's face is generally aligned with the center of the module's face. A door switch is electrically coupled via a controller to the first and second map lamps such that power is applied to the first and second map lamps when the door switch indicates that the vehicle door is open and power is cut off to the first and second map lamps when the door switch indicates that the vehicle door is closed.

In yet another embodiment a light module mounted in a headliner of an automotive vehicle having a first lamp which is manually switchable by a first switch electrically coupled to the first lamp, a second lamp which is manually switchable by a second switch electrically coupled to the second lamp, and a dome lamp is disclosed. The first and second lamps are displaced from a center of the module's face symmetrically and the center axis of the dome lamp's face is generally aligned with the center axis of the module's face. In one embodiment, the first and second switches are integrated within first and second lamps. In one alternative, the first and second lamps, the dome lamp, and a door switch mounted at a vehicle door are electrically coupled to a controller. The controller allows power to be provided to the first and second lamps when the door switch indicates that the vehicle door is at least partially open. An advantage of the present invention is that because the lamps are activated by the door switch, that if the particular vehicle is equipped with a speaker and not a dome lamp, the lamps serve the function of the traditional dome lamp. The invention obviates the need for a separate dome lamp which is activated by opening a car door.

Also disclosed is an interior trim panel of an automotive vehicle having an aperture for accepting a module. The module includes two lamps and one other accessory: a lamp, a speaker, a speaker with a bar light, a combination lamp and speaker, a keypad, a video display or any other accessory known in the art. In one embodiment the trim panel is a vehicle headliner. Alternatively, the trim panel is in the car door, the instrument panel, or any other known trim panel.

Another advantage of the present invention is that by placing the accessories in a module, the opening in the vehicle's headliner (or other installation place in the vehicle's cabin) is the same for all variants of the vehicle. This eases complication in the manufacturing process.

The above advantages and other advantages and features of the present invention will be apparent from the following detailed description of the preferred embodiments when taken in connection with the accompanying drawings.

### BRIEF DESCRIPTION OF THE DRAWINGS

FIG. 1 is a diagrammatic representation of the module with multiple optional embodiments of the present invention;

FIGS. 2A and 2B are diagrammatic representations of two alternative configurations for the module;

FIG. 3 shows the electrical connections between the components of the module, other switches, and the controller; and

FIG. 4 is an exploded perspective view of the module mounted in a vehicle headliner.

### DETAILED DESCRIPTION

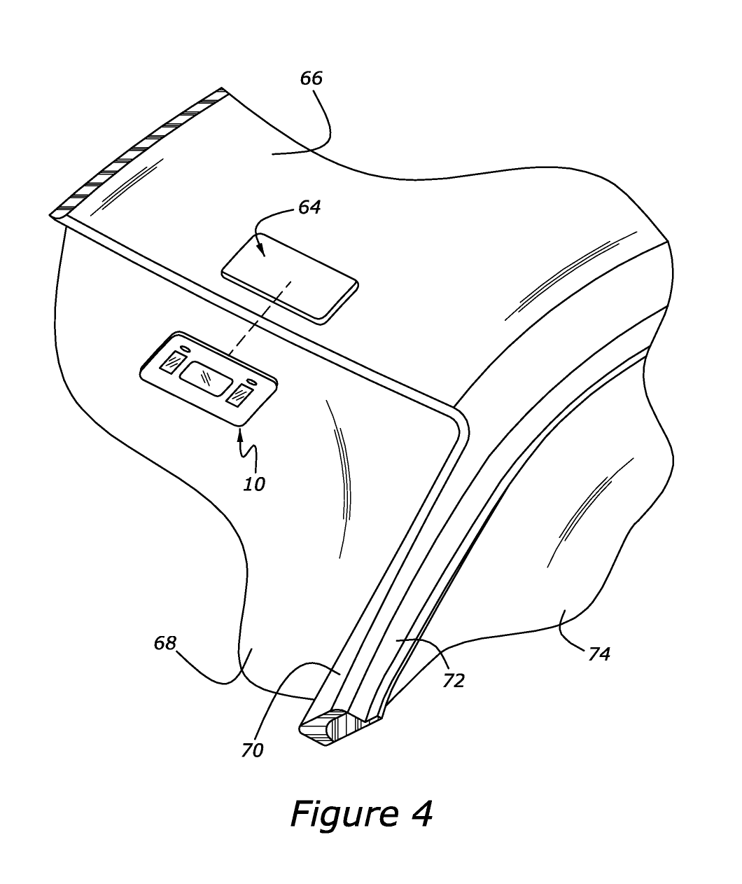

Referring to FIG. 4, a module 10 is shown mounted in a vehicle headliner 66 which has an aperture 64. Also shown in FIG. 4 are the A-pillar 68 and windshield 70 for purposes of providing context of an aspect of the invention. The embodiment shown in FIG. 4 is provided as an example and not intended to be limiting.

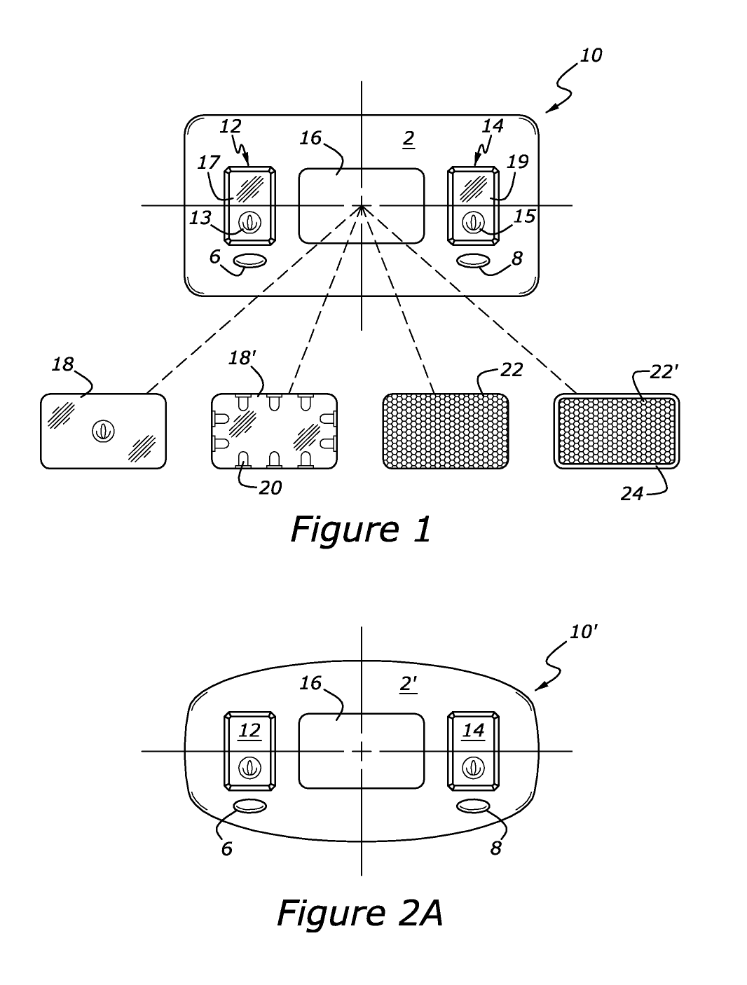

An exemplary embodiment of the present invention is shown in FIG. 1 in a module 10 having a housing 2 into which map lamps 12 and 14 are mounted symmetrically with respect to the face of module 10 is shown. Map lamps 12 and 14 are controlled by switches 6 and 8, respectively, which are also mounted in housing 2. Alternatively, switches 6 and 8 are integrated into map lamps 12 and 14. In one alternative, an occupant of the vehicle presses on the lamp's cover to actuate the switch depressing the lamp's cover on the frame of lamps 12 and 14. Lamps 12 and 14 can include incandescent bulbs, light emitting diodes (LEDs), or any other known luminescent device. An aperture 16 is centrally located in housing 2 for accommodating an accessory. One such alternative is for a dome lamp 18 to be mounted into aperture 16. Lamp 18 has an incandescent bulb. Alternative 18′ shows LEDs. These examples are not intended to be limiting. In another embodiment, speaker 22 is mounted in housing 2. Alternative 22′ shows a speaker with a light bar around the periphery. The lights in the light bar are LEDs, or any other lighting alternative.

One of the advantages of the present invention is that a variety of accessories can be mounted into aperture 16 of module 10 without affecting the way that module 10 is mounted into the headliner (as shown in FIG. 4). That is, only one headliner design can accommodate all the variations in accessories.

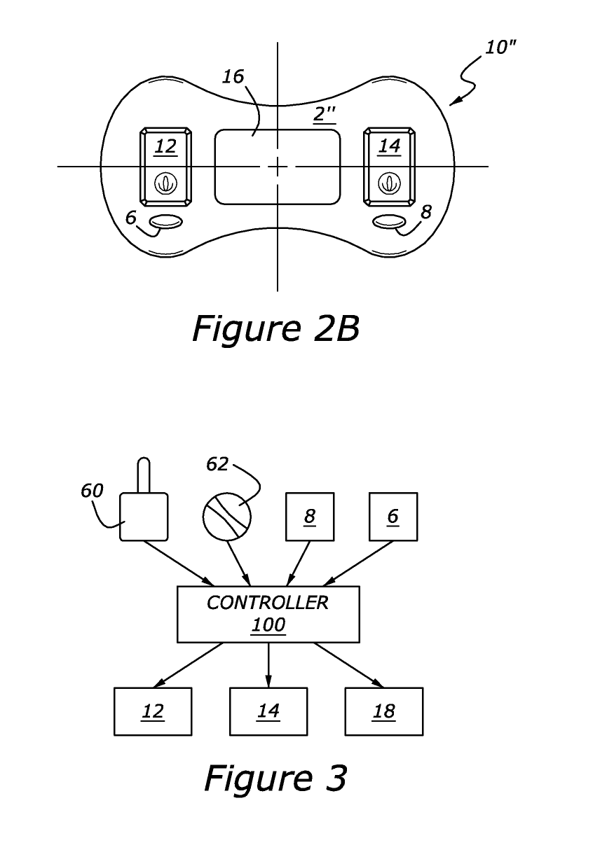

In FIG. 2, alternative outside shapes for housing 2 are shown as housings 2′ and 2″. In all variants, the center of the accessory that fits into aperture 16 is generally coincident with the center of housing 2, 2′ or 2″. Also, lamps 12 and 14 are mounted in symmetrical fashion from the center of the face of housing 2. Aperture 16 is shown in FIG. 1 and FIG. 2 as being generally rectangular with rounded corners. This is not intended to be limiting. Aperture 16, as well as the accessories adapted to fit into aperture 16, can have any shape. Also, lamps 12 and 14 are shown as generally rectangular shapes. However, this is shown by way of example and not intended to be limiting.

In FIG. 3, a controller 100 is shown. This may be a stand alone controller or part of a comprehensive controller which manages body, engine, transmission, and other engine components. The disposition of lamp switches 6 and 8, as well as door switch 60 and instrument panel switch 62 are inputs to controller 100. Lamps 12 and 14 and dome lamp 18 (or 18′) are controlled based on the position of door switch 60 and instrument panel switch 62.

Recall that in at least one embodiment, no dome lamp is provided. When door switch 60 indicates that the door is open, controller 100 causes power to be supplied to lamps 12, 14, and 18. Controller 100, in one embodiment, has a timer function which causes power to be turned off to lamps 12, 14, and 18 after a period of time following the door opening, e.g., 5 minutes, to avoid draining the vehicle's battery (not shown). Switch 6 can be used by the vehicle occupants to control map lamp 12; and switch 8 to control map lamp 18.

In one embodiment, switch 62 is a switch mounted on the vehicle instrument panel for allowing the vehicle operator to manually turn on dome lamp 18. Alternatively, switch 62 is mounted elsewhere in the vehicle's cabin within reach of the vehicle operator. If speaker 22 were to be mounted in aperture 16 (FIG. 1), no switch 62 is provided. If speaker 22′ is mounted in aperture 16 (FIG. 1), the bar light on speaker 22′ may be controlled as lamp 18 is controlled, with respect to one or both of switches 60 and 62. Alternatively, the bar light on speaker 22′ may be part of the vehicle's ambient lighting scheme controlled separately.

In FIG. 3, a single door switch 60 is shown. However, most modern vehicles are equipped with a door switch on each door, possibly including a hatch. In such an embodiment multiple switches are included. Lamps 12, 14, and 18 can be powered by having any one of those multiple switches 60 indicating that a door is open, a parallel circuit. Alternatively, only some of door switches 60 powers lamps 12, 14, and 18.

In FIG. 4, a vehicle headliner 5 is shown which contains an aperture 7 into which module 10 can be mounted. Alternatively, aperture 7 could be provided in a door trim panel, an instrument panel, or any other interior trim panel.

An automotive vehicle is a car, a light duty truck, a bus, a boat, a heavy duty truck, a tractor, or any other vehicle which moves relative to the ground and has a cabin for occupants of the vehicle.

While particular embodiments of the invention have been shown and described, numerous variations and alternate embodiments will occur to those skilled in the art. For example, mounting in a headliner is shown. Those skilled in the art will understand that the present invention can be practiced with any interior trim panels such as pillar covers, door covers, and instrument panels. Accordingly, it is intended that the invention be limited only by the appended claims.

1. A module mounted in an interior aperture in an automotive vehicle, the module comprising:
a housing adapted to be mounted in the vehicle interior aperture;
first and second switch-controllable lamps mounted in the housing; and
an accessory mounted in a centrally-located accessory aperture wherein the vehicle has a controller electrically coupled to the lamps and a door switch.

2. The module of claim 1 wherein the accessory comprises a dome lamp having an incandescent lamp and the dome lamp is electrically coupled to the controller.

3. The module of claim 1 wherein the accessory comprises a dome lamp mounted having at least one light emitting diode (LED) and the dome lamp is electrically coupled to the controller.

4. The module of claim 3 wherein the LED is one of a green, an orange, a red, a blue, and a yellow LED.

5. The module of claim 1 wherein the controller coupled to door power to be provided to the first and second lamps when the disposition of the door switch indicates to the controller that a vehicle door is open.

6. The module of claim 1 wherein the first and second lamps are activated by a vehicle occupant by depressing a cover of the first and second lamps.

7. The module of claim 1 wherein the accessory comprises a speaker.

8. The module of claim 7 wherein the speaker has a light bar.

9. The module of claim 8 wherein the light bar is mounted at the periphery of the speaker and the light bar has LEDs.

10. The module of claim 7 wherein a center of the speaker is generally coincident with a center of the face of the housing.

11. (canceled)

12. A module adapted to be mounted in a headliner of an automotive vehicle, the module comprising:
a housing;
a first lamp mounted into the housing;
a door switch;
a speaker mounted into the housing; and
a controller electrically coupled to the lamps and the door switch wherein the controller controls the lamps based on a position of the door switch.

13. The module of claim 12 wherein the door switch is coupled to the vehicle proximate a vehicle door, power is applied to the first and second lamps when the door switch indicates that the vehicle door is open, and power is cut off to the first and second lamps when the door switch indicates that the vehicle door is closed.

14. The module of claim 12 further comprising:
a light bar coupled to the speaker and electrically coupled to the controller wherein the controller controls the light bar based on the position of the door switch.

15. The module of claim 12 wherein the center of the speaker is generally aligned with the center of the housing and the first and second lamps are displaced symmetrically from the speaker.

16. An automotive vehicle, comprising:
a controller;
a light module comprising:
a housing;
a first lamp mounted into the housing and electrically coupled to the controller;
a dome lamp mounted in the housing and electrically coupled to the controller; and
an instrument panel switch electrically coupled to the controller.

17. The vehicle of claim 16 wherein the controller allows power to be provided to the first lamp based on the instrument panel switch.

18. The vehicle of claim 16, further comprising:
a door switch electrically coupled to the controller wherein the light module further comprises: a second lamp electrically coupled to the controller and the controller allows power to be provided to the first and second lamps when the door switch indicates that the vehicle door is at least partially open.

19. The light module of claim 18 wherein bulbs in the first and second lamps and the dome lamp are one of an incandescent bulb and a light emitting diode (LED).

20. The light module of claim 18 wherein the first and second lamps are displaced from a center of the housing symmetrically and a center of the dome lamp is generally aligned with a center of the housing.

21. The module of claim 14 wherein the controller allows power to be applied to the lamp bar when the door switch indicates that the vehicle door is open and the controller cuts off power to the lamp bar when the door switch indicates that the vehicle door is closed.
